(19) United States
(12) Patent Application Publication
(10) Pub. No.: US 2014/0176446 A1
(43) Pub. Date: Jun. 26, 2014

(54) Adaptive Keyboard for Mobile Devices

(71) Applicant: Futurewei Technologies, Inc., Plano, TX (US)

(72) Inventor: Xiaoyong Yi, Fremont, CA (US)

(21) Appl. No.: 13/722,775

(22) Filed: Dec. 20, 2012

(51) Int. Cl. G06F 3/023

(52) U.S. Cl. CPC G06F 3/023
USPC 345/169

(57) ABSTRACT

A mobile device comprising a processor, and a touch screen coupled to the processor and configured to display a plurality of keyboard pages in a sequential order, wherein the keyboard pages comprise a plurality of relocatable keys, and wherein the relocatable keys are relocatable based on their proportionate frequency of usage.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Mobile devices may comprise touch screen displays configured to display a keyboard. Due to the small size of the screens, mobile devices may use multiple fixed pages to display the keyboard keys. In such cases, a user clicks a key on one keyboard page to access keys displayed on the following page. Thus, a user has to perform several clicks and go through multiple pages in order to reach a character on the last page. If a character on the last page is often used, the user must perform the several clicks on a regular basis, which makes for an unpleasant user experience.

### SUMMARY

In an embodiment, a mobile device is provided. The mobile device includes a processor and a touch screen that is coupled to the processor and configured to display a plurality of keyboard pages in a sequential order. The keyboard pages comprise a plurality of relocatable keys, and the relocatable keys are relocatable based on their proportionate frequency of usage.

In an embodiment, provided is a method for reconfiguring a mobile device touch-screen keyboard. The keyboard includes at least a first keyboard page, a second keyboard page, and a third keyboard page, and the keyboard pages contain relocatable keys. The method includes displaying the keyboard pages in a sequential order on a mobile device touch screen. The method includes relocating a first relocatable key from one of the first keyboard page, the second keyboard page, or the third keyboard page to another one of the first keyboard page, the second keyboard page, or the third keyboard page. The relocating is based on the first relocatable key's frequency of execution.

In an embodiment, a computer program product is provided for reconfiguring a plurality of mobile device keyboard pages that comprise a plurality of relocatable keys. The computer program product is stored in a non-transitory medium. The computer program product is configured to designate a weight value to each relocatable key. The computer program product is configured to detect execution of a first relocatable key located on a second page, and increase the weight value of the first relocatable key based on the execution. The computer program product is further configured to relocate the first relocatable key based on the increase in weight.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1A is a schematic diagram of a first page of an embodiment of a reconfigurable keyboard displayed on a mobile device screen.

FIG. 1B is a schematic diagram of a second page of an embodiment of the reconfigurable keyboard displayed on a mobile device screen.

FIG. 1C is a schematic diagram of a third page of an embodiment of the reconfigurable keyboard displayed on a mobile device screen.

FIG. 2A is a schematic diagram of the first page of the reconfigurable keyboard of FIG. 1A after the keyboard has been reconfigured in accordance with an embodiment.

FIG. 2B is a schematic diagram of the second page of the reconfigurable keyboard of FIG. 1B after the keyboard has been reconfigured in accordance with an embodiment.

FIG. 2C is a schematic diagram of the third page of the reconfigurable keyboard of FIG. 1C after the keyboard has been reconfigured in accordance with an embodiment.

FIG. 3 depicts a flowchart for a process of reconfiguring a keyboard according to an embodiment.

FIG. 4A is a schematic diagram of the first page of the reconfigurable keyboard of FIG. 1A after the keyboard has been reconfigured in accordance with another embodiment.

FIG. 4B is a schematic diagram of the second page of the reconfigurable keyboard of FIG. 1B after the keyboard has been reconfigured in accordance with another embodiment.

FIG. 4C is a schematic diagram of the third page of the reconfigurable keyboard of FIG. 1C after the keyboard has been reconfigured in accordance with another embodiment.

FIG. 5 depicts a flowchart for a process of reconfiguring a keyboard according to the embodiment of FIGS. 4A-4C.

FIG. 6 is a schematic drawing of an embodiment of a mobile device into which an embodiment of the present reconfigurable keyboard may be incorporated.

### DETAILED DESCRIPTION

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

Mobile devices may comprise touch screens for displaying keyboards containing keys. Due to the small size of the touch screens, the keyboard keys may be displayed by way of a plurality of sequentially accessible keyboard pages (e.g., a first keyboard page, a second keyboard page, and a third keyboard page). In operation, upon a user accessing the keyboard, a first page is displayed on the screen, thereby allowing the user to execute keys on the first page. If the user then wishes to use a key on the second page, the user first gains access to the second page by clicking a “jump to second page” key. Likewise, if the user has access to the first page but wishes to use a key on the third page, then the user first clicks the “jump to second page” key in order to access the second page and, from the second page, clicks the “jump to third page” key in order to access the third page. For users that use character keys on the third page frequently, the repetitious clicking of the “jump to” keys may serve as time consuming and burdensome. Accordingly, disclosed herein is a reconfigurable keyboard for incorporation into a mobile device that reduces the number of times a user must click the “jump to” keys throughout usage. In doing so, the disclosed reconfigurable keyboard relocates keys so that frequently used keys are more easily accessible to the user.

The mobile device may comprise a processor that is configured to monitor a user's usage of the keys and reconfigure the keyboard accordingly. Reconfiguring the keyboard may comprise relocating frequently used keys to keyboard pages that are more accessible to the user. Thus, the reconfigurable keyboard adapts to each particular user and thereby offers a more time efficient and pleasant user experience.

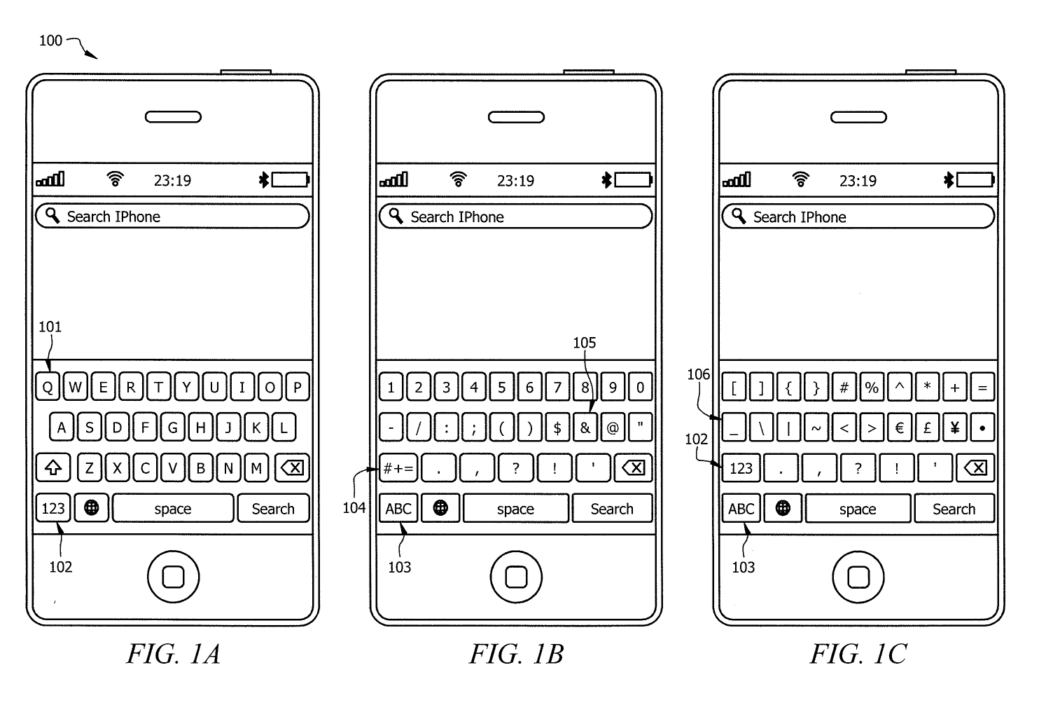

FIGS. 1A-1C are schematic diagrams of an embodiment of the mobile device keyboard displayed on a mobile device touch screen. The keyboard may be displayed across multiple pages, each page comprising a plurality of keys. The mobile device 100 may comprise a touch screen 101 coupled to a processor and configured to display one keyboard page at a time in a sequential order. FIG. 1A depicts the mobile device displaying a first page, FIG. 1B depicts the mobile device displaying a second page, and FIG. 1C depicts the mobile device displaying a third page. The first page may comprise a plurality of character keys and functional keys. One skilled in the art will appreciate that the character keys displayed on the first page may represent any variety of symbols, icons, and/or characters. In the particular embodiment shown in FIG. 1A, at least some of the character keys on the first screen represent alphabetic characters. The first screen also comprises a “jump to second page” functional key 102. Upon the user clicking the “jump to second page” key 102, the touch screen displays the second page, which is depicted in FIG. 1B. The second page comprises a plurality of character keys and functional keys. One skilled in the art will appreciate that the character keys displayed on the second page may represent any variety of symbols, icons, and/or characters. In the particular embodiment shown in FIG. 1B, at least some of the character keys on the second page represent numerical characters and at least some of the character keys on the second page represent special characters. The second page also comprises a “jump to first page” functional key 103 as well as a “jump to third page” functional key 104. Upon a user clicking the “jump to first page” key 103, the touch screen displays the first page as depicted in FIG. 1A. Upon the user clicking the “jump to third page” key 104, the touch screen displays the third page as depicted in FIG. 1C. The third page comprises a plurality of character keys and functional keys. One skilled in the art will appreciate that the character keys displayed on the third page may represent any variety of symbols, icons, and/or characters. In the particular embodiment shown in FIG. 1C, at least some of the character keys on the third page represent special characters. The third page also comprises a “jump to first page” key 103 as well as a “jump to second page” key 102. Upon the user clicking the “jump to first page” key 103, the touch screen displays the first page. Upon the user clicking the “jump to second page” key 102, the touch screen displays the second page. Herein, the first page is designated as the most convenient page since, in operation, it is accessed first by the user, while the last page (e.g., the third page) is designated as the least convenient page. Although the FIG. 1 embodiment comprises three pages, one skilled in the art will recognize that the quantity of three is merely exemplary and that the keyboard may comprise any number of pages.

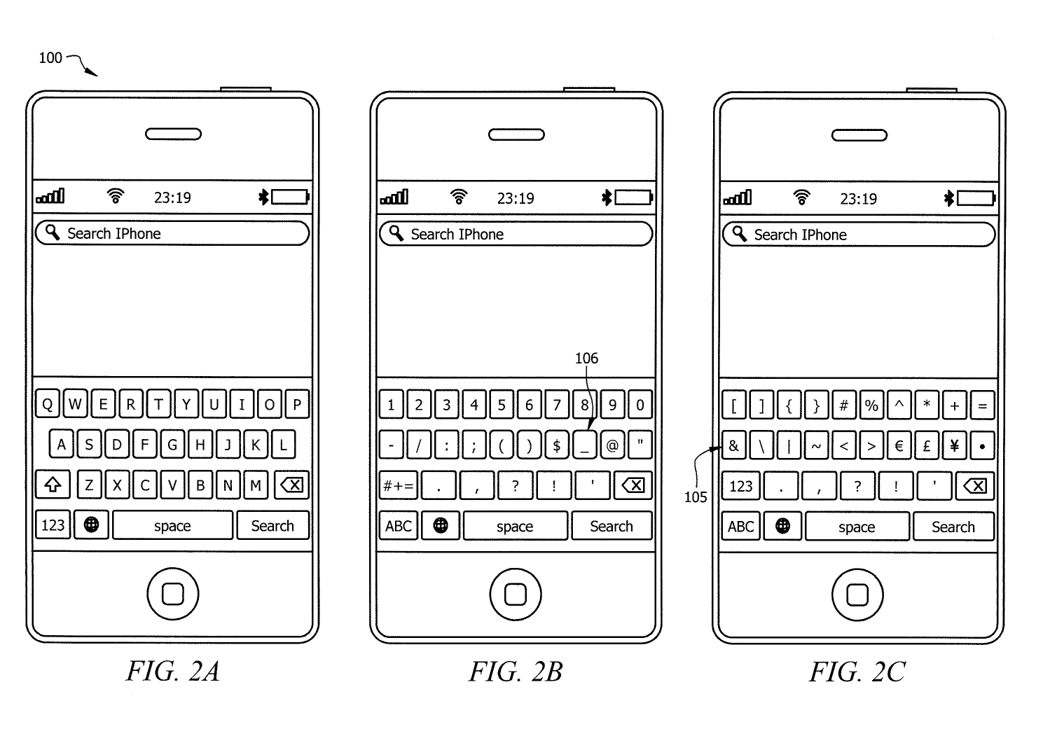

FIGS. 2A-2C illustrate the keyboard as shown in FIGS. 1A-1C after it has been adaptively reconfigured by the processor according to an embodiment. As seen in FIGS. 1B and 1C, prior to the reconfiguration, the depicted keyboard comprises an ampersand (“&”) key 105 on the second page and an underscore (“ ”) key 106 on the third page. The exemplary user of this mobile device embodiment, however, used the underscore key 106 frequently and rarely used the ampersand key 105. As a result, the FIG. 1 keyboard was adaptively reconfigured so that the underscore key 106 moved from the third page to a more convenient page (e.g., to the second page), exchanging locations with the ampersand key 105. Thus, the reconfigured keyboard shown in FIGS. 2B and 2C comprises the underscore key 106 on the second page and the ampersand key 105 on the third page. As seen from FIGS. 1A and 2A, the first screen was not changed during the particular reconfiguration.

In an embodiment, some of the character keys are relocatable while other character keys are non-relocatable but remain on their initial pages. For example, in an embodiment, the alphabetic keys are non-relocatable and thus remain on the first page, and the numerical keys are non-relocatable and thus remain on the second page, while the special character keys are relocatable and move among pages according to their usage. In an embodiment, the user is capable of controlling the settings in order to choose which character keys are non-relocatable.

Reconfiguration may take place by way of a processor that is configured to monitor the usage of the character keys and reconfigure the keyboard according thereto. In doing so, the processor may first designate to each relocatable key a particular weight. The mobile device may be sold to a user with all the weights of the character keys on each page equal to one another. For example, the character keys on the first page are each designated a first weight value, the character keys on the second page are each designated a second weight value, and the character keys on the third page are each designated a third weight value, wherein the first weight value is greater than the second and third weight values, and wherein the second weight value is greater than the third weight value. Thus, the character keys possessing higher weight values are located on more convenient pages. The processor may refrain from designating weight values to the non-relocatable keys.

The processor may be configured so that each time a user executes a relocatable character key, the relocatable character key's weight value increases by an incremental amount. Thus, frequently used keys will acquire a higher weight value than less frequently used keys. The processor may also be configured to reconfigure the keyboard such that more convenient pages contain relocatable character keys of higher weight values, while less convenient pages contain relocatable character keys of lower weight values. As a result, because more frequently used keys will acquire higher weight values, the more frequently used keys will be moved to the more convenient pages. Consequently, the keyboard may be adaptable to a particular user, thereby providing the user with easy access to the keys most frequently used.

In some embodiments, the keyboard may not undergo reconfiguration until it is initiated. Thus, while the weight values of the relocatable keys are monitored and stored, the relocatable keys relocate only upon a reconfiguration initiation. In some embodiments, a user initiates a reconfiguration. In other embodiments, the initiation occurs after a fixed amount of time has elapsed. In some embodiments the user can control how often a reconfiguration is initiated (e.g., once a week). In other embodiments, reconfiguration frequency is fixed by the manufacturer. In other embodiments, the reconfiguration initiation is controlled by a communications network associated with the mobile device (e.g., via software updates). In some embodiments, a user can control through the user settings whether keyboard reconfigurations take place at all.

In some embodiments, the keyboard is automatically reconfigurable without requiring an initiation. For example, in an embodiment, a first relocatable key on a less convenient page may exchange locations with a second relocatable key on a more convenient page as soon as the first relocatable key's weight value exceeds that of the second relocatable key. In another embodiment, a first relocatable key on a less convenient page may exchange locations with a second relocatable key on a more convenient page only upon the first relocatable key's weight value exceeding the weight value of the second relocatable key by a predetermined amount. This predetermined amount may be set in order to prevent the keys from changing locations too frequently and thereby confusing the user. In an embodiment, the predetermined amount is fixed (e.g., by the mobile device manufacturer). In another embodiment, the predetermined amount may be altered by the user, so the keyboard is reconfigurable more or less often according to the user's preferences.

In some embodiments, a reconfiguration may require user authorization for specific relocations. For example, before relocating a relocatable key to a different page, the user may be asked to authorize the reconfiguration. If the user answers yes, then the reconfiguration takes place. If, on the other hand, the user says no, then the reconfiguration will not take place. The user may also have the opportunity to answer “never relocate this key.” In such cases, the key is designated as a non-relocatable key and the key's weight value is no longer accounted for in the reconfiguration analysis. The user may also have the opportunity to answer “always relocate this key when necessary.” In such cases, the key will be relocated according to its usage without again asking for the user's authorization.

FIGS. 1A-1C and 2A-2C exemplify an embodiment wherein a reconfiguration takes place across subsets wherein the subsets comprise keyboard pages. However, in other embodiments the reconfiguration may take place across different keyboard subsets besides pages. For example, a first keyboard page may comprise a first subset and a second subset which span across three rows of relocatable keys. The first subset may comprise the bottom two rows of relocatable keys, and the second subset may comprise the top row of relocatable keys. The first subset comprising the bottom two rows of relocatable keys may be designated a higher hierarchical order than the second subset since the first subset may be more accessible to a user. Thus, the keyboard may be reconfigurable so that a more frequently executed relocatable key located in the second subset exchanges location with a less frequently executed relocatable key located in the first subset. Such reconfiguration can occur according to the reconfiguration described above in FIGS. 1A-1C and 2A-2C.

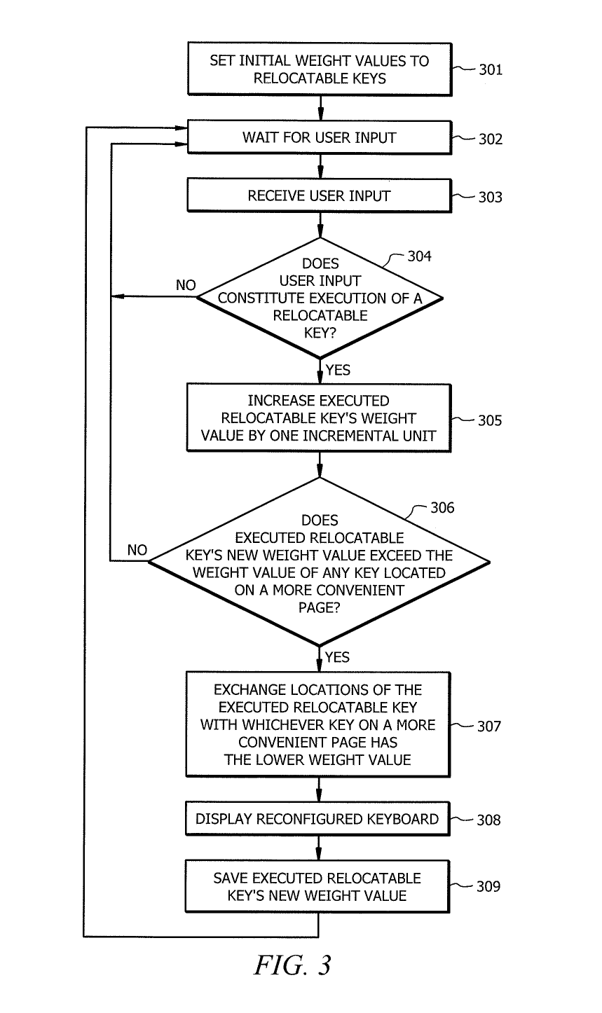

FIG. 3 illustrates a flowchart of the method performed by the processor for reconfiguring the keyboard according to the FIGS. 2A-2C embodiment, which may be run anytime the mobile device is powered on. In step 301, the processor sets the initial weight values to the relocatable character keys. In step 302, the processor waits for user input. In step 303, the processor receives user input upon a user executing a command on the touch page. In step 304, the processor determines whether the user input constitutes execution of a relocatable key. If the user input did not constitute execution of a relocatable key, then it returns to step 302. If the user input constitutes execution of a relocatable key, then the process moves to step 305 and the executed relocatable key's weight value increases by one incremental unit. In step 306, the processor determines whether the executed relocatable key's new weight value exceeds the weight value of any key on a more convenient page. If not, then it returns to step 302. If the answer to step 306 is yes, then it moves to step 307 and the executed relocatable key exchanges locations with whichever key on the more convenient page has the lower weight value. One example of such location exchange is described above with reference to FIGS. 2A-2C. In step 308, the reconfigured keyboard is displayed. In step 309, the executed relocatable key's new weight value is saved, and the process returns to step 302.

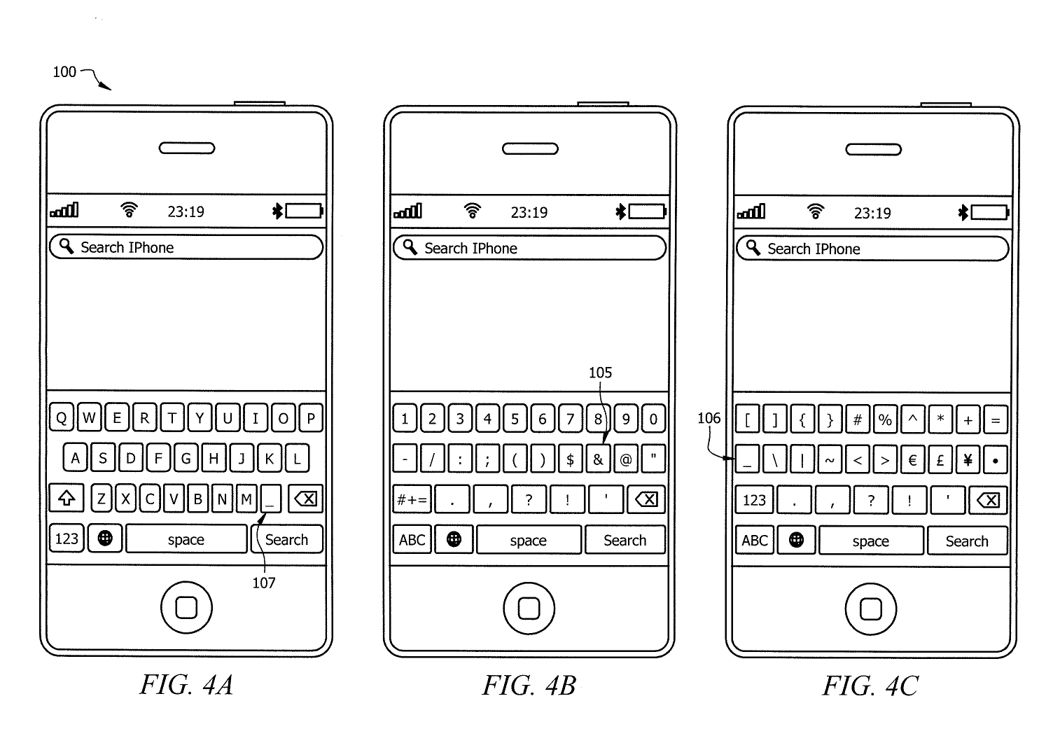

Referring now to FIGS. 4A-4C, shown is an embodiment wherein the keyboard pages comprise at least one preferred portion. The at least one preferred portion may contain character keys, at least some of which may be non-relocatable. In the particular embodiment shown in FIG. 4A, the alphabetic character keys are non-relocatable and remain in a first preferred portion on the first page. As seen in FIG. 4B, the top row of the second page may also comprise a second preferred portion comprising numerical keys that are non-relocatable.

In the FIG. 4 embodiment, a copy of a relocatable key may appear in the first preferred portion if the weight of the relocatable key exceeds the weight of all the other relocatable keys by a threshold amount. Thus, FIGS. 1A-1C and FIGS. 2A-2C illustrate the first preferred portion before a reconfiguration thereof. FIGS. 4A-4C illustrate the first preferred portion after it has been reconfigured to include a copy of the underscore (“ ”) character key 107. As seen in FIGS. 1A, 2A, and 4A, when the first preferred portion is reconfigured to include a copy of the underscore key, the copy of the underscore key becomes included in the preferred portion, but none of the non-relocatable keys are removed from the preferred portion. Thus, the preferred portion reconfiguration causes the total number of keys contained in the preferred portion to increase. The inclusion of the copy of the underscore key may occur upon a user executing the underscore key so frequently that its weight exceeds the weight of all the other relocatable keys by a threshold value.

As seen in FIGS. 4B and 4C, when a copy of the underscore key 107 appears in the preferred portion, the original underscore key 106 is thereupon designated the lowest weight value and thus relocates from the second page to the third page. As the original underscore key 106 relocates to the third page, the relocatable key with the highest weight value of the relocatable keys in the third page moves to the second page to take the place of the original underscore key. As seen in FIGS. 4B and 4C, in the embodiment, the ampersand (“&”) key 105 is the relocatable key that exchanges locations with the original underscore key 106.

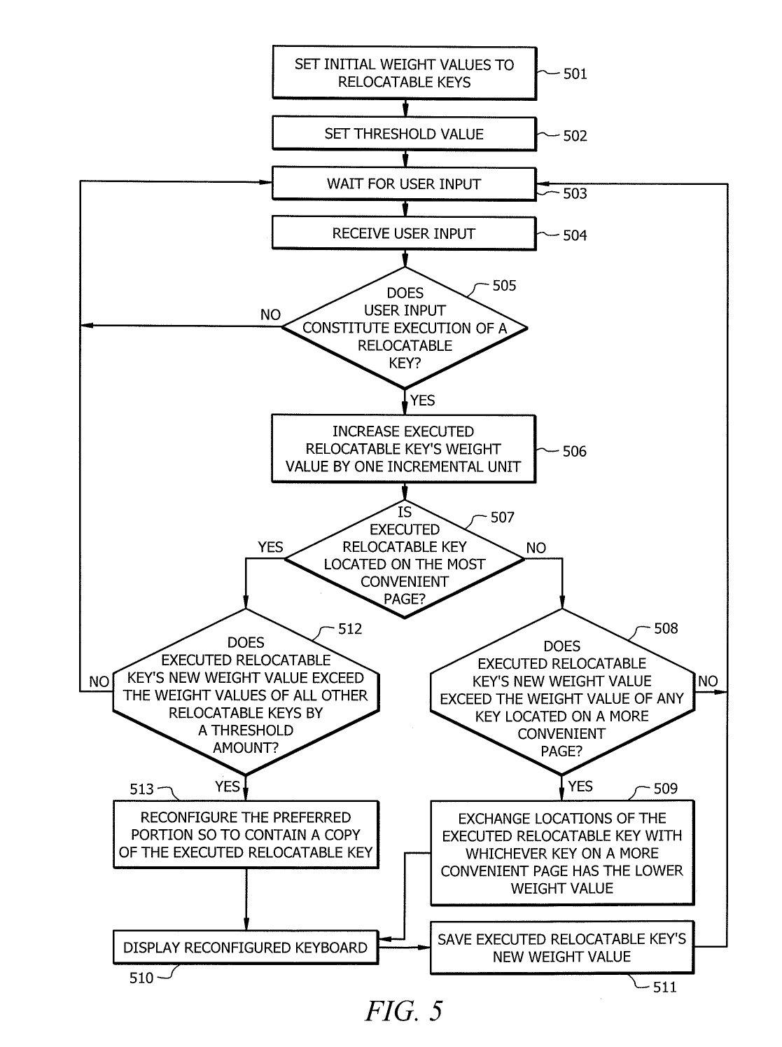

FIG. 5 illustrates a flowchart of the method performed by the processor for reconfiguring the keyboard comprising a preferred portion according to the FIG. 4 embodiment, which may be run anytime the mobile device is powered on. Initially, at least one preferred portion is established. In some embodiments, the at least one preferred portion is designated by the user, and the user selects which keys, if any, are non-relocatable. In other embodiments, the at least one preferred portion is designated by the manufacturer and the user does not have control over which keys are non-relocatable. For example, the manufacturer may designate first and second preferred portions and pre-program the mobile device such that the alphabetic keys and numerical keys are non-relocatable and remain in the first and second preferred portions respectively. In step 501, the processor sets the initial weight values to the relocatable character keys. In step 502, the processor sets a threshold value which a relocatable key must exceed in order to move to the first preferred portion. In step 503, the processor waits for user input. In step 504, the processor receives user input upon a user executing a command on the mobile device. In step 505, the processor determines whether the user input constitutes execution of a relocatable key. If the user input did not constitute execution of a relocatable key, then the process returns to step 503. If the user input constitutes execution of a relocatable key, then, at 506, the processor increases the executed relocatable key's weight value by one incremental unit. In step 507, the processor determines whether the executed relocatable key is located on the most convenient page.

If, at step 507, it is determined that the executed relocatable key is not located on the most convenient page, then the processor moves to step 508 and determines whether the executed relocatable key's new weight value exceeds the weight value of any key on a more convenient page. If not, then it returns to step 503. If, on the other hand, the answer at step 508 is yes, then it moves to step 509 and the executed relocatable key exchanges locations with whichever key on the more convenient page has the lower weight value. In step 510, the reconfigured keyboard is displayed. In step 511, the executed relocatable key's new weight value is saved, and the process returns to step 503.

If, at step 507, it is determined that the executed relocatable key is located on the most convenient page, then the processor moves to step 512 and determines whether the executed relocatable key's weight value exceeds the weight value of all the other relocatable keys by a threshold value. If the answer to step 512 is no, then it returns to step 503. If the answer to step 512 is yes, then the preferred portion will be reconfigured so as to contain the executed relocatable key at step 513. As a result thereof, a second relocatable key contained on the third page and having the highest weight value of all other relocatable keys on the third page will move to the executed relocatable key's location on the second page. Also, a copy of the executed relocatable key will be placed in the second relocatable key's place on the third page. In step 510, the reconfigured keyboard is displayed. In step 511, the executed relocatable key's new weight value is saved, and the process returns to step 503.

In some embodiments, an initiation may be required for the keyboard to undergo the preferred portion reconfiguration. Thus, while the weight values of the relocatable keys are monitored and stored, the most frequently used relocatable key is not copied and relocated until and unless the preferred portion reconfiguration is initiated. In some embodiments, a user initiates such reconfiguration. In other embodiments, the initiation occurs after a fixed amount of time has elapsed. In some embodiments the user can control how often a preferred portion reconfiguration is initiated (e.g., once a week). In other embodiments, such reconfiguration frequency is fixed by the manufacturer. In other embodiments, the reconfiguration initiation is controlled by a communications network associated with the mobile device (e.g., via software updates).

In some embodiments, the keyboard is automatically reconfigurable without requiring an initiation. For example, in an embodiment, the processor may be configured so that upon the weight value of the relocatable key exceeding the weight value for all other relocatable keys by the threshold amount, the relocatable key is relocated and a copy of the relocatable key is included in the preferred portion. In some embodiments, the particular threshold value may be altered in order to make such reconfigurations take place more or less frequently. In some embodiments, the threshold value is fixed by the manufacturer. In other embodiments, the user may control the threshold value through the user settings.

In some embodiments, the preferred portion reconfiguration may require user authorization. For example, before including a copy of a relocatable key in a preferred portion and relocating the relocatable key, the user may be asked to authorize the reconfiguration. If the user answers yes, then the reconfiguration takes place. If, on the other hand, the user says no, then the reconfiguration will not take place. The user may also have the opportunity to answer “never include a copy of this key in the preferred portion.” In such cases, the processor will never determine whether the weight value of the relocatable key exceeds the weight value of the other relocatable keys by a threshold value. The user may also have the opportunity to answer “always conduct a preferred portion reconfiguration for this key when necessary.” In such cases, the key will be copied and relocated according to its usage without again asking for the user's authorization.

In some embodiments, the user may turn off the preferred portion reconfiguration so copies of relocatable keys never become included in the preferred portion. In some embodiments, a user may lock the preferred portion in place. In cases when a user locks the preferred portion in place, whichever relocatable key is included in the preferred portion at the time of the lock will remain in the preferred portion until the user decides to unlock the preferred portion. When the preferred portion is locked, the processor refrains from determining whether the weight value of a relocatable key located on the most convenient page exceeds the weight values of all other relocatable keys by a threshold value.

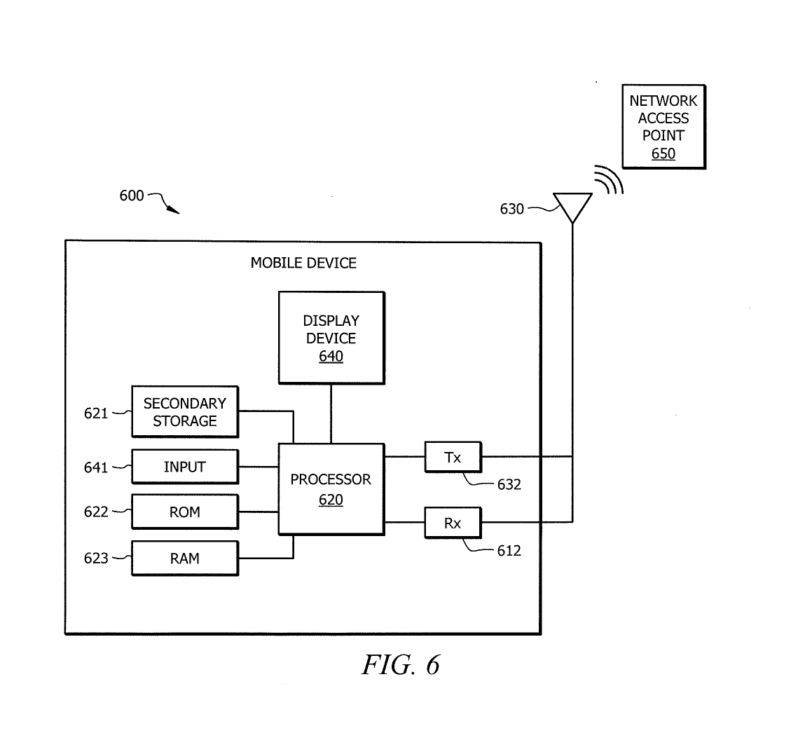

FIG. 6 is a schematic diagram of a mobile device into which the reconfigurable keyboard may be incorporated. Mobile device 600 may comprise a processor 620 (which may be referred to as a central processor unit or CPU) that is in communication with memory devices including secondary storage 621, read only memory (ROM) 622, and random access memory (RAM) 623. The processor 620 may be implemented as one or more general purpose CPU chips, one or more cores (e.g., a multi-core processor), or may be part of one or more application specific integrated circuits (ASICs) and/or digital signal processors (DSPs). The processor 620 may be configured to implement any of the schemes described herein, and may be implemented using hardware, software, firmware, or combinations thereof.

The secondary storage 621 may be comprised of one or more solid state drives, disk drives, and/or other memory types and is used for non-volatile storage of data and as an over-flow data storage device if RAM 623 is not large enough to hold all working data. Secondary storage 621 may be used to store programs that are loaded into RAM 623 when such programs are selected for execution. The ROM 622 may be used to store instructions and perhaps data that are read during program execution. ROM 622 may be a non-volatile memory device may have a small memory capacity relative to the larger memory capacity of secondary storage 621. The RAM 623 may be used to store volatile data and perhaps to store instructions. Access to both ROM 622 and RAM 623 may be faster than to secondary storage 621.

The mobile device 600 may communicate data (e.g., packets) wirelessly with a network via a network access point 650. As such, the mobile device 600 may comprise a receiver (Rx) 612, which may be configured for receiving data (e.g. wireless packets or frames) from other components. The receiver 612 may be coupled to the processor 620, which may be configured to process the data and determine to which components the data is to be sent. The mobile device 600 may also comprise a transmitter (Tx) 632 coupled to the processor 620 and configured for transmitting data to other components, for example by using protocols such as Institute of Electrical and Electronics Engineers (IEEE) 802.11, IEEE 802.16, 3rd Generation Partnership Project (3GPP), Global System for Mobile Communications (GSM), or similar wireless protocols. The receiver 612 and transmitter 632 may be coupled to at least one antenna 630, which may be configured to receive and transmit wireless radio frequency (RF) signals. In some embodiments, Tx 632 and Rx 612 may be replaced by a transceiver comprising the functionality of both Tx 632 and Rx 612.

The mobile device 600 may also comprise a display device 640 coupled to the processor 620, that displays output thereof to a user. The mobile device 600 and the display device 640 may configured to display representations of data to a user. The display device 620 may comprise a Color Super Twisted Nematic (CSTN) display, a thin film transistor (TFT) display, a thin film diode (TFD) display, an organic light-emitting diode (OLED) display, an active-matrix OLED display, or any other display screen. The display device 640 may display in color or monochrome and may be equipped with a touch sensor based on resistive and/or capacitive technologies.

The mobile device 600 may further comprise an input device 641 coupled to the processor 620, which may allow the user to input commands to the mobile device 600. In the case that the display device 640 comprises a touch sensor, the display device 640 may also be considered the input device 641. In addition to and/or in the alternative, an input device 641 may comprise a mouse, trackball, built-in keyboard, external keyboard, and/or any other device that a user may employ to interact with the mobile device 600.

It is understood that by programming and/or loading executable instructions onto the mobile device 600, at least one of the processor 620, memory 621-623, and/or Rx/Tx 612/632 are changed, transforming the mobile device 600 in part into a particular machine or apparatus, e.g., a mobile communication device having novel and adaptive reconfiguration characteristics. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an ASIC, because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

At least one embodiment is disclosed and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 5, 4, etc.; greater than 0.10 includes 0.11, 0.12, 0.15, etc.). For example, whenever a numerical range with a lower limit, R₁, and an upper limit, Rᵤ, is disclosed, any number falling within the range is specifically disclosed. In particular, the following numbers within the range are specifically disclosed: R=R₁+k*(Rᵤ-R₁), wherein k is a variable ranging from 1 percent to 100 percent with a 1 percent increment, e.g., k is 1 percent, 2 percent, 5 percent, 4 percent, 5 percent, . . . , 50 percent, 51 percent, 52 percent, . . . , 95 percent, 96 percent, 97 percent, 98 percent, 99 percent, or 100 percent. Moreover, any numerical range defined by two R numbers as defined in the above is also specifically disclosed. The use of the term about means±10% of the subsequent number, unless otherwise stated. Use of the term “optionally” with respect to any element of a claim means that the element is required, or alternatively, the element is not required, both alternatives being within the scope of the claim. Use of broader terms such as comprises, includes, and having should be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present disclosure. The discussion of a reference in the disclosure is not an admission that it is prior art, especially any reference that has a publication date after the priority date of this application. The disclosure of all patents, patent applications, and publications cited in the disclosure are hereby incorporated by reference, to the extent that they provide exemplary, procedural, or other details supplementary to the disclosure.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A mobile device comprising:
a processor; and
a touch screen coupled to the processor and configured to display a plurality of keyboard pages in a sequential order,
wherein the keyboard pages comprise a plurality of relocatable keys, and
wherein the relocatable keys are relocatable based on their proportionate frequency of usage.

2. The mobile device of claim 1, wherein the relocatable keys do not relocate until a reconfiguration is initiated.

3. The mobile device of claim 1, wherein each relocatable key is designated a weight value, and wherein the weight value of a relocatable key increases by a predetermined incremental amount upon execution of the relocatable key.

4. The mobile device of claim 3, wherein the keyboard pages comprise a plurality of subsets, wherein the plurality of subsets possesses a hierarchical order such that each subset is either higher or lower than each other subset, and wherein the subsets are arranged on the keyboard pages according to the hierarchical order.

5. The mobile device of claim 4, wherein if the weight value of a first relocatable key located in a lower subset exceeds the weight value of a second relocatable key located in a higher subset, then the first relocatable key will exchange locations with the second relocatable key.

6. The mobile device of claim 4, wherein a first subset is arranged on the first page, a second subset is arranged on the second page, and a third subset is arranged on the third page, wherein the first page is of a higher hierarchical order than the second page and the third page, and wherein the second page is of a higher hierarchical order than the third page.

7. The mobile device of claim 3, wherein the keyboard pages comprise a preferred portion containing a plurality of non-relocatable keys that remain in the preferred portion.

8. The mobile device of claim 7, wherein, upon the weight of a relocatable key exceeding the weight of all the other relocatable keys by a threshold amount, a copy of the relocatable key is contained in the preferred portion so that the preferred portion comprises the copy of the relocatable key as well as the plurality of non-relocatable keys.

9. The mobile device of claim 7, wherein the non-relocatable keys comprise at least one key representing an alphabetic character.

10. A method for reconfiguring a mobile device touch-screen keyboard, wherein the keyboard comprises at least a first keyboard page, a second keyboard page, and a third keyboard page; wherein the keyboard pages contain relocatable keys, the method comprising:
displaying the keyboard pages in a sequential order on a mobile device touch screen; and
relocating a first relocatable key from one of the first keyboard page, the second keyboard page, or the third keyboard page to another one of the first keyboard page, the second keyboard page, or the third keyboard page based on the first relocatable key's frequency of execution.

11. The method of claim 10, wherein relocating the first relocatable key does not occur until a reconfiguration is initiated.

12. The method of claim 10, further comprising designating a weight value to each relocatable key, wherein the weight value of a relocatable key increases by a predetermined incremental amount upon execution of the relocatable key.

13. The method of claim 12, further comprising:
detecting execution by a user of the first relocatable key; and
increasing the weight value of the first relocatable key based on the execution.

14. The method of claim 13, further comprising:
determining that the weight value of the first relocatable key exceeds the weight value of a second relocatable key, wherein the second relocatable key is located on a keyboard page that precedes in sequential order the keyboard page on which the first relocatable key is located; and
exchanging the locations of the first relocatable key and the second relocatable key based on the determination that the weight value of the first relocatable key exceeds the weight value of the second relocatable key.

15. The method of claim 12, wherein the keyboard pages comprise at least one preferred portion containing non-relocatable keys that remain in the preferred portion, and wherein the method further comprises:
detecting execution by a user of a relocatable key not located in the preferred portion;
increasing the weight value of the first relocatable key based on the execution;
determining that the increased weight value of the first relocatable key exceeds the weight values of all other relocatable keys by a threshold amount; and
adding a copy of the first relocatable key to the preferred portion so that the preferred portion comprises the copy of the first relocatable key as well as the plurality of non-relocatable keys based on the determination.

16. A computer program product for reconfiguring a plurality of mobile device keyboard pages comprising a plurality of relocatable keys, wherein the computer program product is stored in a non-transitory medium, and wherein the computer program is configured to:
designate a weight value to each relocatable key;
detect execution of a first relocatable key located on a second page;
increase the weight value of the first relocatable key based on the execution; and
relocate the first relocatable key based on the increase in weight value.

17. The computer program of 16, wherein relocating the first relocatable key comprises relocating the first relocatable key from the second page to a first page.

18. The computer program of claim 16, wherein the keyboard pages further comprise a second relocatable key located on the first page, and wherein relocating the first relocatable key comprises exchanging the locations of the first relocatable key and the second relocatable key based on the weight value of the first relocatable key exceeding the weight value of the second relocatable key.

19. The computer program of claim 16, wherein the keyboard pages further comprise a preferred portion, and wherein relocating the first relocatable key comprises adding a copy of the first relocatable key to the preferred portion such that the number of keys contained in the preferred portion increases by one, and wherein adding the copy of the first relocatable key is based on the weight value of the first relocatable key exceeding a threshold value.

20. The computer program of claim 19, wherein the preferred portion comprises at least one key representing an alphabetic character.
